(19) United States
(12) Patent Application Publication
(10) Pub. No.: US 2012/0092877 A1
(43) Pub. Date: Apr. 19, 2012

(54) LAMP HOLDER, LAMP UNIT, AND VIDEO PROJECTOR

(75) Inventors: Kazuya Minami, Hirakata-shi (JP); Seiji Yamamoto, Osaka-shi (JP)

(73) Assignee: SANYO ELECTRIC CO., LTD., Osaka (JP)

(21) Appl. No.: 13/270,539

(22) Filed: Oct. 11, 2011

(30) Foreign Application Priority Data
Oct. 13, 2010 (JP) 2010-230905

(51) Int. Cl. F21V 15/00; F21V 21/00

(52) U.S. Cl. 362/362; 362/396

(57) ABSTRACT

A lamp holder that holds a lamp, which is a light source for displaying an image, in a lamp housing. The lamp holder includes an elastic portion, which is held between the lamp and an inner surface of the lamp housing, and a hooking portion, which is fitted into an opening extending through the lamp housing and hooked to an outer surface of the lamp housing.

### CROSS-REFERENCE TO RELATED APPLICATIONS

This application is based upon and claims the benefit of priority from prior Japanese Patent Application No. 2010-230905, filed on Oct. 13, 2010, the entire contents of which are incorporated herein by reference.

### BACKGROUND ART

The present invention relates to a lamp holder that holds a lamp in a lamp housing, a lamp unit including such a lamp holder, and a video projector including such a lamp unit.

A typical video projector includes a lamp housing that covers a lamp, which is a light source for displaying images. A lamp holder is arranged in the lamp housing to hold a lamp. Japanese Laid-Open Patent Publication No. 2003-287812 describes a prior art example of a lamp holder.

In the projector described in the above publication, a first plate spring, which serves as a lamp holder, is attached to a lamp housing. The first plate spring urges a reflector of the lamp toward a side surface of the lamp housing. The side surface functions as a positioning surface. The first plate spring includes a spring engagement portion, which engages the side surface of the lamp housing, and a fastening portion, which is inserted into a hole arranged in the side surface. The spring engagement portion and fastening portion are formed integrally from metal.

However, in the structure such as that described in the above publication, the lamp holder is not rigidly fixed to the lamp housing. Thus, for example, when the first plate spring deforms, the fastening portion of the first plate spring may be separated from the hole in the side surface of the lamp housing. As a result, even when the spring engagement portion of the first plate spring is engaged with the side surface of the lamp housing, displacement of the first plate spring may cause separation of the first plate spring from the lamp housing. A fastener, such as a screw, may be used to fasten the lamp holder to the lamp housing. However, this would increase the number of components and cause the structure to be complicated.

### SUMMARY OF THE INVENTION

A first aspect of the present invention is a lamp holder that holds a lamp, which is a light source for displaying an image, in a lamp housing. The lamp holder includes an elastic portion held between the lamp and an inner surface of the lamp housing. A hooking portion is fitted into an opening extending through the lamp housing and hooked to an outer surface of the lamp housing.

A second aspect of the present invention is a lamp unit including a lamp housing that accommodates a lamp. A lamp holder that holds the lamp in the lamp housing. The lamp holder includes an elastic portion held between the lamp and an inner surface of the lamp housing, and a hooking portion fitted into an opening extending through the lamp housing and hooked to an outer surface of the lamp housing.

A third aspect of the present invention is a video projector including a lamp, which serves as a light source for displaying an image, and a lamp unit. The lamp unit includes a lamp housing, which accommodates the lamp, and a lamp holder, which holds the lamp in the lamp housing. The lamp holder includes an elastic portion, which is held between the lamp and an inner surface of the lamp housing, and a hooking portion, which is fitted into an opening extending through the lamp housing and hooked to an outer surface of the lamp housing.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIGS. 1A and 1B are perspective views showing a projector serving as one embodiment of a video projector;

FIGS. 2A and 2B are perspective views showing a lamp unit of the projector;

FIGS. 3A and 3B are perspective views showing a lamp in the lamp unit;

FIGS. 4A and 4B are perspective views showing a lamp housing of the lamp unit;

FIG. 5A is a plan view showing the lamp housing;

FIGS. 5B and 5C are side views showing the lamp housing;

FIG. 5D is a bottom view showing the lamp housing;

FIG. 6A is a perspective view showing a lamp holder arranged in the lamp housing;

FIG. 6B is a front view showing the lamp housing of FIG. 6A;

FIG. 7 is a perspective view showing the lamp holder in a state arranged in the lamp housing;

FIG. 8 is a partially enlarged cross-sectional view showing the lamp holder in a state arranged in the lamp housing;

FIG. 9 is a perspective view showing the lamp in a state held by the lamp holder;

FIG. 10 is a partially enlarged cross-sectional view showing the lamp in a state held by the lamp holder; and

FIG. 11 is a perspective view showing how an outer frame is coupled to the lamp housing.

### DETAILED DESCRIPTION OF THE INVENTION

A projector 1 serving as one embodiment of a video projector will now be described with reference to the drawings. In the description hereafter, upward and downward directions will be indicated by arrow Z in the drawings. The upward and downward directions are not limited to the vertical direction. Further, forward and rearward directions, which are orthogonal to the upward and downward directions, are indicated by arrow X in the drawings. Further, leftward and rightward directions, which are orthogonal to the upward and downward directions and the forward and rearward direction, are indicated by arrow Y in the drawings.

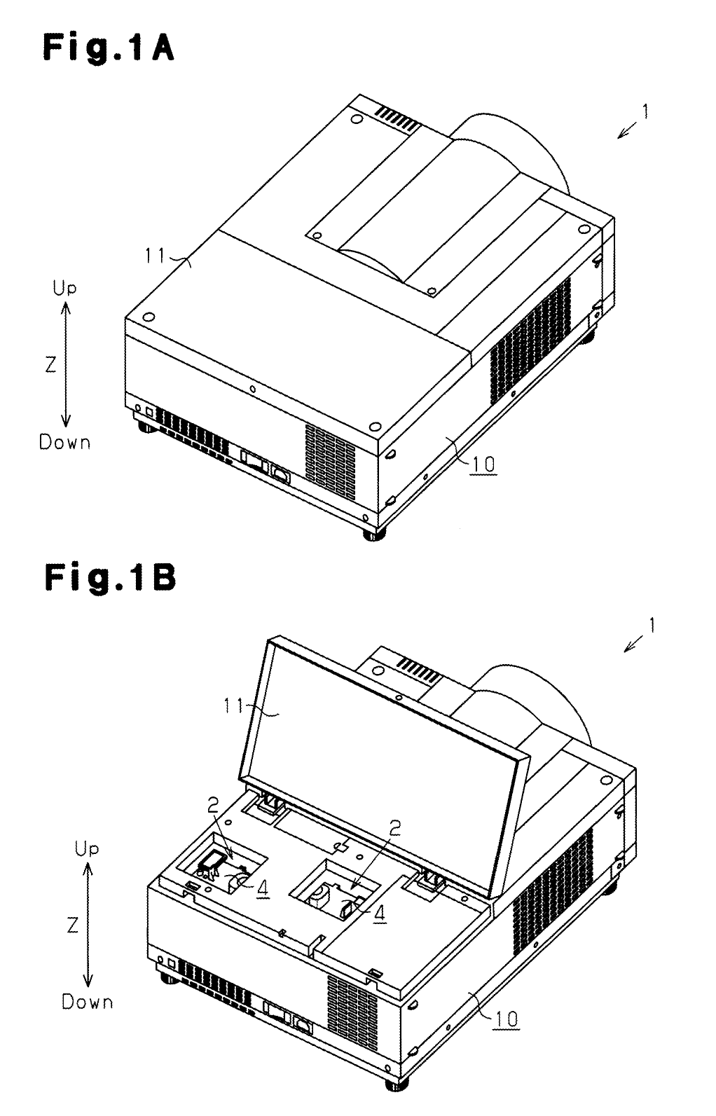

Referring to FIGS. 1A and 1B, the projector 1, which projects and displays an image on a screen, a wall, or the like, includes a case 10, which accommodates electronic components, optical components, or the like. A lamp cover 11 is arranged on the case 10 to open and close the case 10.

The lamp cover 11 may be held in an open state as shown in FIG. 1A or a closed state as shown in FIG. 1B. As shown in FIG. 1B, a lamp unit 2 is arranged in the case 10. When the lamp cover 11 is in the open state, the lamp unit 2 may be removed from or attached to the case 10. In other words, the lamp unit 2 may be replaced by a new one when the lamp cover 11 is in the open state.

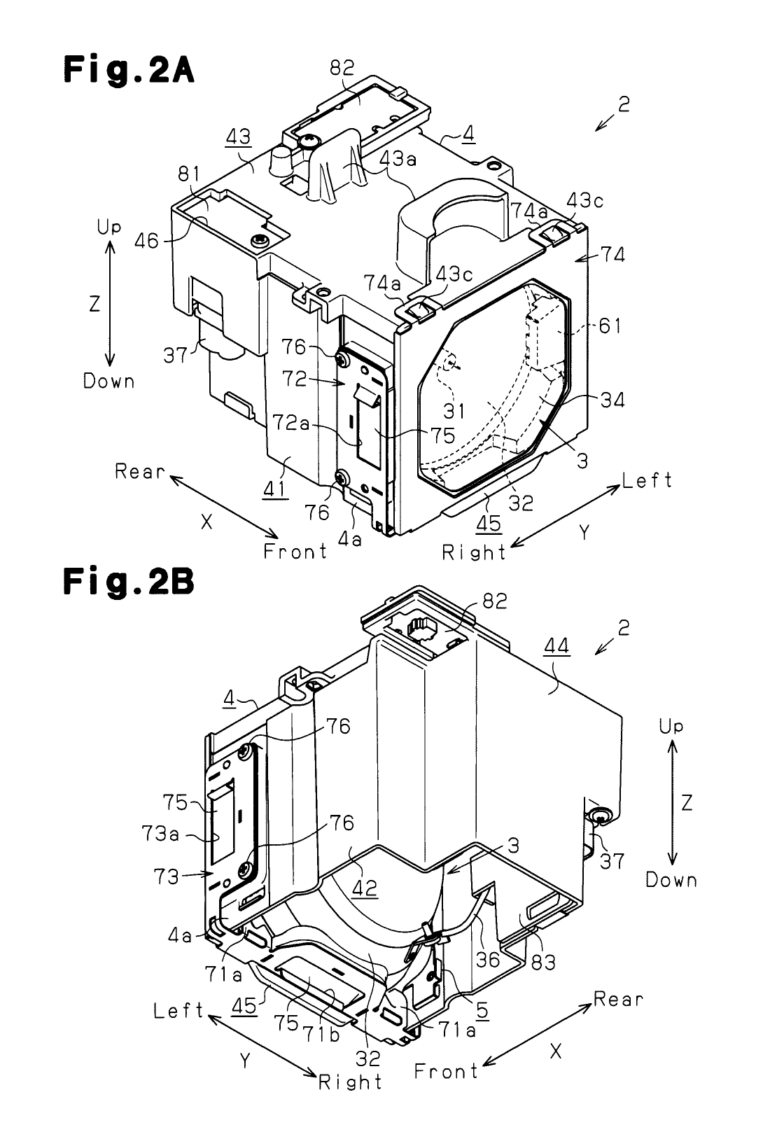

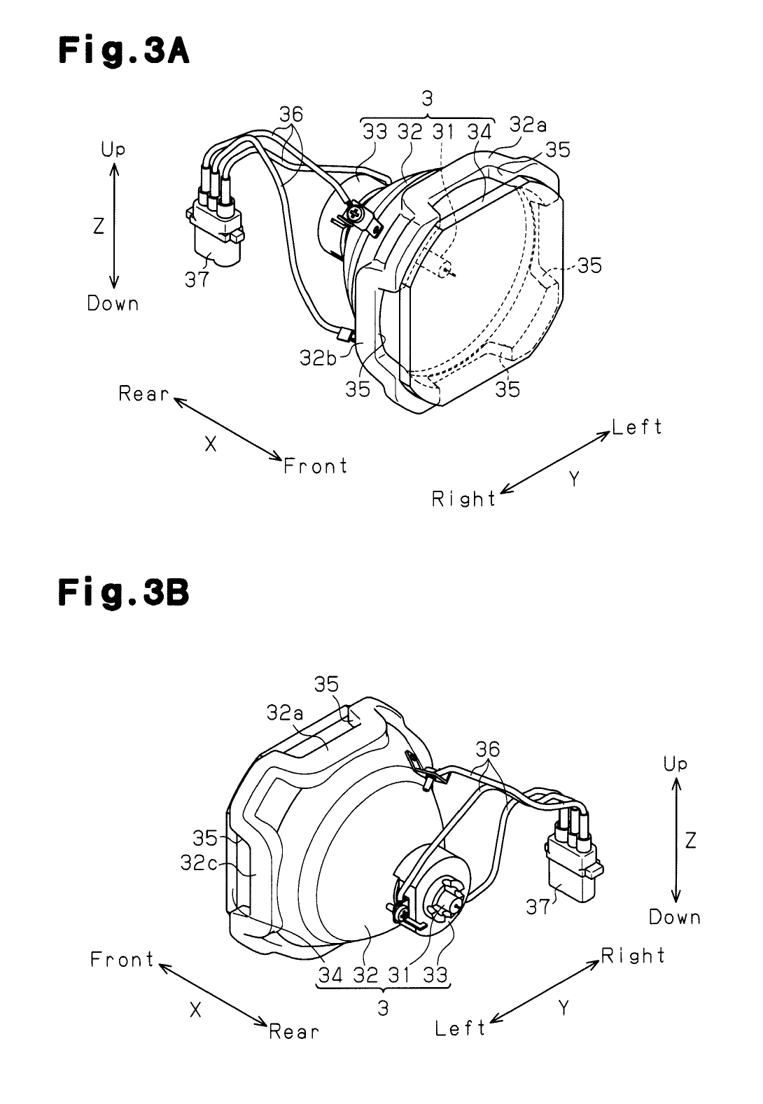

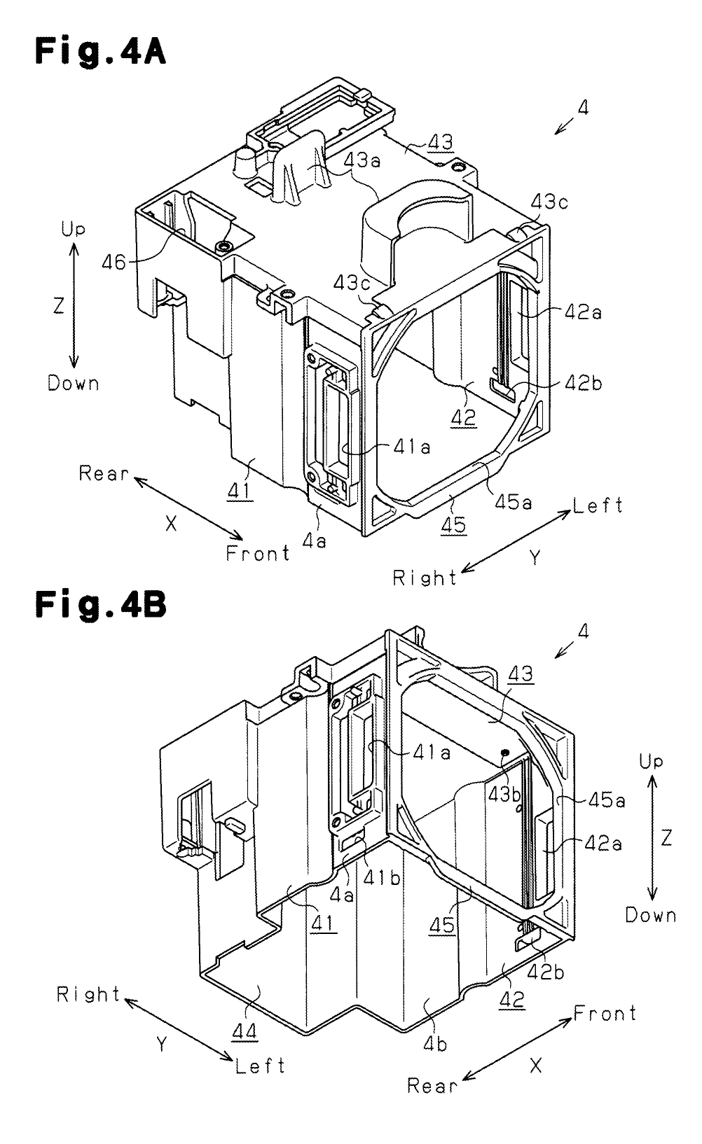

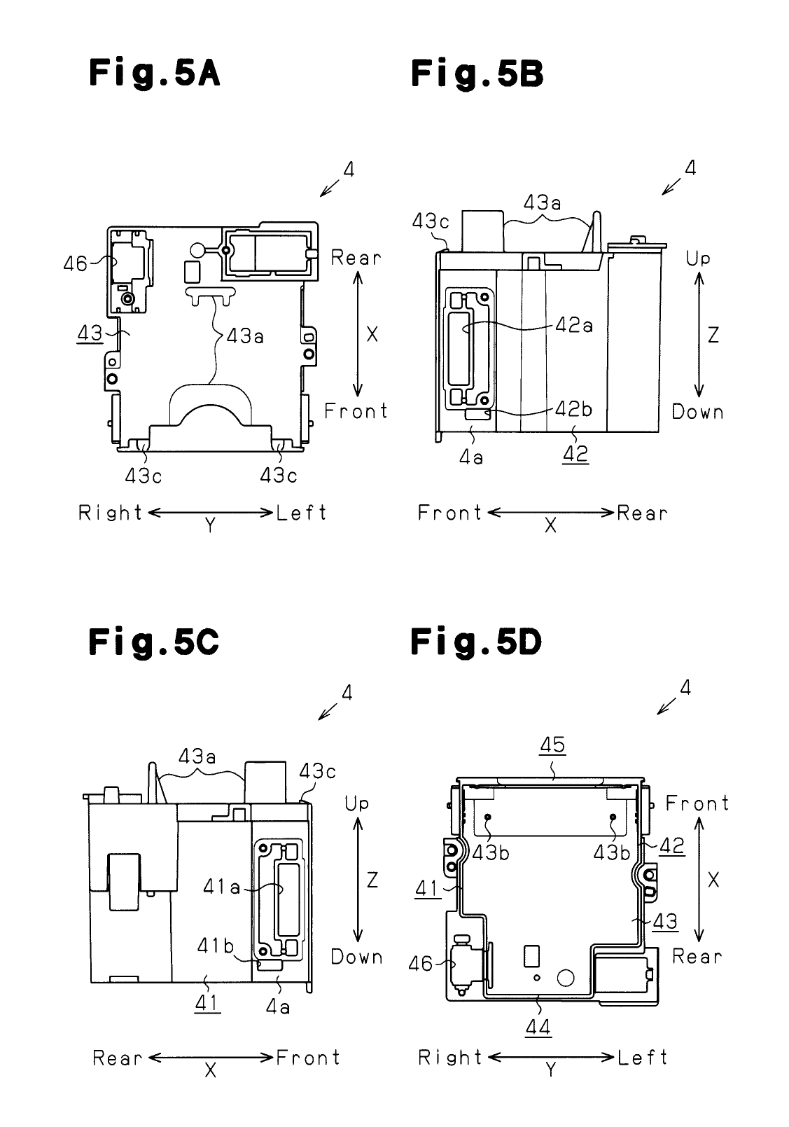

As shown in FIGS. 2A and 2B, the lamp unit 2 includes a box-shaped lamp housing 4, which accommodates a lamp 3. FIGS. 3A and 3B are perspective views showing the lamp 3 in a state removed from the lamp housing 4 shown in FIGS. 2A and 2B. FIGS. 4A, 4B, and 5A to 5D show only the lamp housing 4.

Referring to FIGS. 3A and 3B, the lamp 3, which is a light source for displaying images, is, for example, a discharge lamp. The lamp 3 includes an arc tube 31, which generates light through an electric discharge, a reflector 32, which reflects the light emitted from the arc tube 31 toward the front, an arc tube support 33, which supports the arc tube 31, and a cover glass 34, which is arranged at the front end of the reflector 32.

A luminous body, which is, for example, a mixture or mercury and a halogen gas or halide, is sealed in the arc tube 31. Electric power is supplied to the lamp 3 to apply high voltage to the luminous body sealed in the arc tube 31. This causes a breakdown in the arc tube 31 and generates an electric discharge. In this manner, when an electric discharge is generated in the arc tube 31, the lamp 3 emits light. The arc tube 31 has a shape that is elongated in the forward and rearward directions. The arc tube 31 is partially fitted into the reflector 32. For example, the arc tube 31 has a central portion and front portion arranged in the reflector 32 and a rear portion projected out of the reflector 32.

The reflector 32 is a reflection mirror, which reflects the light emitted from the arc tube 31, and encompasses the arc tube 31. As shown in FIG. 3A, the reflector 32 includes an upper surface 32a and right surface 32b, which are flat. Further, as shown in FIG. 3B, the reflector 32 includes a left surface 32c, which is flat. The upper surface 32a, right surface 32b, and left surface 32c are pressed against the lamp housing 4 shown in FIGS. 2A and 2B.

The arc tube support 33 is located outside the reflector 32 and arranged on the rear end of the reflector 32. The arc tube support 33 supports the rear portion of the arc tube 31 and fixes the arc tube 31 to the reflector 32.

The cover glass 34 is arranged at the front side of the reflector 32 to cover the reflector 32 and the arc tube 31. When the arc tube 31 breaks, the cover glass 34 arranged in front of the arc tube 31 prevents fragments of the arc tube 31 from being scattered. Further, as shown in FIG. 3A, the front end of the reflector 32 includes cutouts that form inlets 35 with the cover glass 34. In the present embodiment, the inlets 35 are arranged at the upper, lower, left, and right sides of the lamp 3.

Cables 36 are connected to the lamp 3 to supply the lamp 3 with power from a power supply circuit (not shown) arranged in the case 10 shown in FIG. 1. The cables 36 are, for example, fixed to the reflector 32 by screws as shown in FIG. 3A and to the arc tube support 33 by a screw as shown in FIG. 3B. Each cable 36 is a flexible cord formed by an electric wire and an insulator that covers the electric wire. Further, each cable 36 has one end connected to the lamp 3 and another end connected to a connector 37. The cable 36 has sufficient length for fixing the corresponding connector 37 to the lamp housing 4 at a predetermined position.

When the lamp unit 2 is placed in the case 10, the connector 37 is connected to a connector (not shown) arranged in the case 10. In this manner, the power supply circuit in the case 10 is electrically connected to the cables 36 to supply the lamp 3 with power and generate electric discharge in the arc tube 31. Although not shown in the drawings, the arc tube 31 includes an electrode, which is used to generate an electric discharge, and an electrode wire, which connects the electrode of the tube 31 to the electric wires of the cables 36.

Referring to FIGS. 4A and 4B, the lamp housing 4, which accommodates the lamp 3, is formed to cover, the right, left, upper, and rear sides of the lamp 3. Namely, the lamp housing 4 includes a right wall 41, a left wall 42, an upper wall 43, and a rear wall 44. The right wall 41 and left wall 42 are spaced apart in the leftward and rightward directions. The upper wall 43 connects the right wall 41 and left wall 42. As shown in FIG. 4B, the rear wall 44 connects the right wall 41, left wall 42, and upper wall 43. Further, the lamp housing 4 includes a front wall 45 that connects front ends of the right wall 41, left wall 42, and upper wall 43. The front wall 45 also includes an opening 45a. The light emitted from the lamp 3 accommodated in the lamp housing 4 travels out of the lamp housing 4 through the opening 45a.

The structures of the walls 41 to 45 of the lamp housing 4 will now be described with reference to FIG. 5.

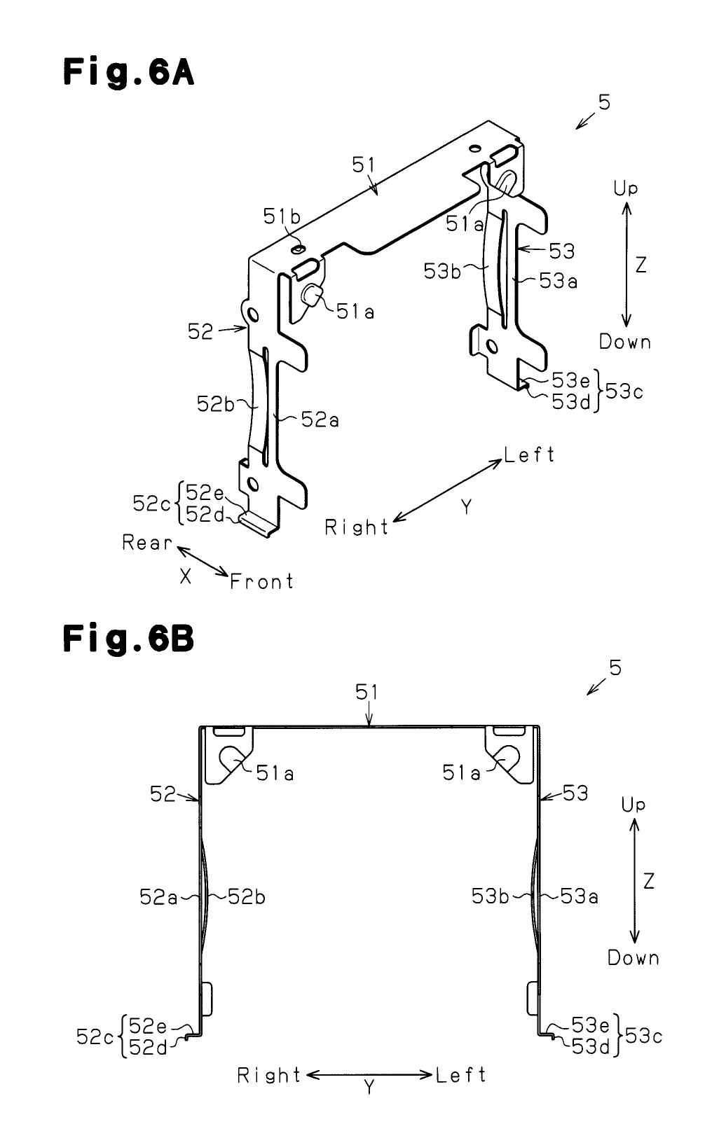

As shown in FIG. 5C, the right wall 41 has a front portion including openings 41a and 41b extending through the lamp housing 4. When the lamp 3 is accommodated in the lamp housing 4, the opening 41a is located at a position overlapped with the right inlet 35 of the lamp 3 as viewed from the right. Further, the opening 41b is arranged below the opening 41a in the right wall 41. The opening 41b receives a lower end of a lamp holder 5, which is shown in FIG. 6.

As shown in FIG. 5B, in the same manner as the right wall 41, the left wall 42 has a front portion including openings 42a and 42b extending through the lamp housing 4. When the lamp 3 is accommodated in the lamp housing 4, the opening 42a is located at a position overlapped with the left inlet 35 of the lamp 3 as viewed from the left. Further, the opening 42b is arranged below the opening 42a in the left wall 42. The opening 42b receives the lower end of the lamp holder 5 shown in FIG. 6.

As shown in FIG. 5A, the upper wall 43 includes a grip 43a used by an operator to hold the lamp housing 4 when replacing the lamp unit 2. As shown in FIG. 5B, the grip 43a is projected upward from the lamp housing 4.

As shown in FIG. 5D, the rear wall 44 and the front wall 45 are spaced apart from each other in the forward and rearward directions. The lamp 3 has a front end, which is pressed against the front wall 45, and a rear end, which is spaced apart from the rear wall 44 even when the lamp 3 is accommodated in the lamp housing 4. This allows, when assembling the lamp unit 2, an operator to insert his or her hand or a tool into the gap between the rear end of the lamp 3 and rear wall 44.

In the present embodiment, the lamp 3, which is accommodated in the lamp housing 4, is held by the lamp holder 5 shown in FIG. 6.

As shown in FIGS. 6A and 6B, the lamp holder 5 includes a base 51, a right holding arm 52, and a left holding arm 53. The right holding arm 52 and left holding arm 53 each serve as a holding portion. The base 51 is a plate extending in the leftward and rightward directions. The right holding arm 52 is bendable relative to the base 51 and connected to a right end of the base 51. The left holding arm 53 is bendable relative to the base 51 and connected to a left end of the base 51.

An elastic portion, or elastic tab 51a, which applies elastic force in the forward and rearward directions, is arranged on each of left and right front ends of the base 51. The elastic tabs 51a are bent downward from the bases 51. Further, part of the front end of the base 51 extends toward the front. As shown in FIG. 6A, holes 51b extend through the base 51. Referring to FIG. 5D, the upper wall 43 includes projections 43b, which are fitted to the holes 51b.

The right holding arm 52 includes a flat right basal portion 52a and an elastic portion 52b, which applies elastic force in the leftward and rightward directions. The elastic portion 52b is curved and bulged toward the left at the middle. Thus, the elastic portion 52b is formed by a curved portion. The elastic portion 52b extends in the upward and downward directions and is spaced apart from part of the right basal portion 52a in the forward and rearward directions. The elastic portion 52b has upper and lower ends connected to the right basal portion 52a. Parts of the front end of the right basal portion 52a extend toward the front.

Further, the right holding arm 52 includes a hooking portion 52c formed at its lower end. The hooking portion 52c is fitted into the opening 41b shown in FIG. 5C and hooked to an outer surface 4a of the lamp housing 4. The hooking portion 52c includes an abutment section 52d, which abuts the outer surface 4a of the lamp housing 4, and a connection section 52e, which is fitted into the opening 41b. The connection section 52e connects the right basal portion 52a and elastic portion 52b to the abutment section 52d.

The left holding arm 53 includes a flat left basal portion 53a and an elastic portion 53b, which applies elastic force in the leftward and rightward directions. The elastic portion 53b is curved and bulged toward the right at the middle. Thus, the elastic portion 53b is formed by a curved portion. The elastic portion 53b extends in the upward and downward directions and is spaced apart from part of the left basal portion 53a in the forward and rearward directions. The elastic portion 53b has upper and lower ends connected to the left basal portion 53a. Parts of the front end of the left basal portion 53a extend toward the front.

Further, the left holding arm 53 includes a hooking portion 53c formed at its lower end. The hooking portion 53c is fitted into the opening 42b shown in FIG. 5B and hooked to the outer surface 4a of the lamp housing 4. The hooking portion 53c includes an abutment section 53d, which abuts the outer surface 4a of the lamp housing 4, and a connection section 53e, which is fitted into the opening 42b. The connection section 53e connects the left basal portion 53a and elastic portion 53b to the abutment section 53d.

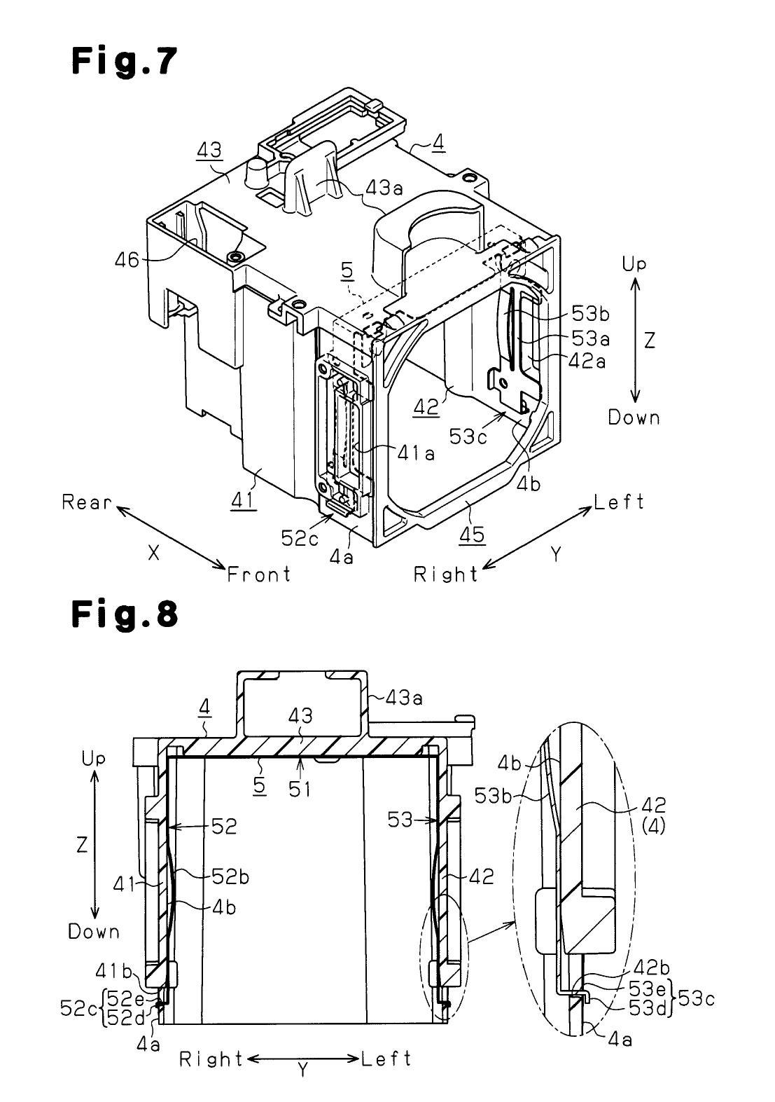

With reference to FIGS. 7 to 10, one example of a process for assembling the lamp unit 2, which holds the lamp 3 with the lamp holder 5, will now be described.

As shown in FIGS. 7 and 8, the lamp holder 5 is arranged in the lamp housing 4 before accommodating the lamp 3.

Referring to FIG. 8, to couple the lamp holder 5 to the lamp housing 4, the hooking portion 52c is fitted into the opening 41b and the hooking portion 53c is fitted into the opening 42b. The hooking portions 52c and 53c are respectively fitted into the openings 41b and 42b from inside the lamp housing 4. Here, the right holding arm 52 and the left holding arm 53 are entirely bent so that the abutment sections 52d and 53d do not interfere with an inner surface 4b of the lamp housing 4. The fitting of the connection sections 52e and 53e into the openings 41b and 42b hooks the hooking portions 52c and 53c to the outer surface 4a of the lamp housing 4.

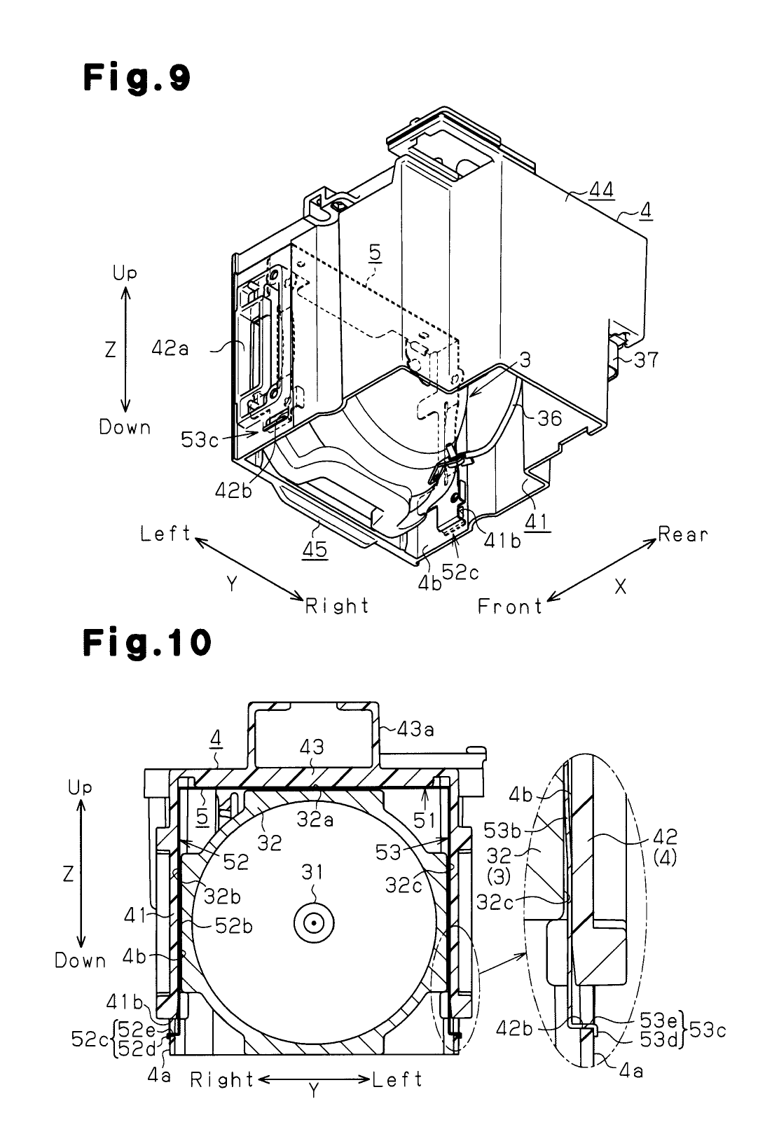

Referring to FIGS. 9 and 10, the lamp 3 is arranged from the lower side in the lamp housing 4, to which the lamp holder 5 is coupled.

As shown in FIG. 10, when the lamp 3 is accommodated in the lamp housing 4, the elastic portion 52b is held between the inner surface 4b of the right wall 41 (lamp housing 4) and the lamp 3. Further, the elastic portion 53b is held between the inner surface 4b of the left wall 42 (lamp housing 4) and the lamp 3. In the present embodiment, the elastic portion 52b is held between the inner surface 4b and the right surface 32b of the reflector 32, and the elastic portion 53b is held between the inner surface 4b and a left surface 32c of the reflector 32. Here, when the elastic portion 52b is held between the inner surface 4b and the lamp 3, the connection section 52e is drawn into the lamp housing 4. As a result, the abutment section 52d, which is connected to the elastic portion 52b by the connection section 52e, is pressed against the outer surface 4a of the right wall 41. In the same manner, when the elastic portion 53b is held between the inner surface 4b and the lamp 3, the connection section 53e is drawn into the lamp housing 4. As a result, the abutment section 53d, which is connected to the elastic portion 53b by the connection section 53e, is pressed against the outer surface 4a of the left wall 42.

More specifically, as shown by the partially enlarged view in FIG. 8, when the lamp 3 is not accommodated in the lamp housing 4, the abutment section 53d does not remain hooked to the outer surface 4a. In contrast, as shown by the partially enlarged view in FIG. 10, when the lamp 3 is accommodated in the lamp housing 4, the abutment section 53d remains hooked to the outer surface 4a. In the same manner, when the lamp 3 is not accommodated in the lamp housing 4, the abutment section 52d does not remain hooked to the outer surface 4a. When the lamp 3 is accommodated in the lamp housing 4, the abutment section 52d remains hooked to the outer surface 4a. Accordingly, the lamp holder 5 rigidly holds the right end of the lamp 3 with the right holding arm 52 and rigidly holds the left end of the lamp 3 with the left holding arm 53.

In the present embodiment, when the lamp 3 is accommodated in the lamp housing 4, the right upper end and left upper end of the reflector 32 are pressed forward by the elastic tabs 51a shown in FIG. 6. That is, the elastic tabs 51a press the upper end of the lamp 3 against the front wall 45 of the lamp housing 4. In this manner, in the present embodiment, the lamp holder 5 presses the lamp 3 against the lamp housing 4 in the leftward and rightward directions and presses the lamp 3 in the forward and rearward directions.

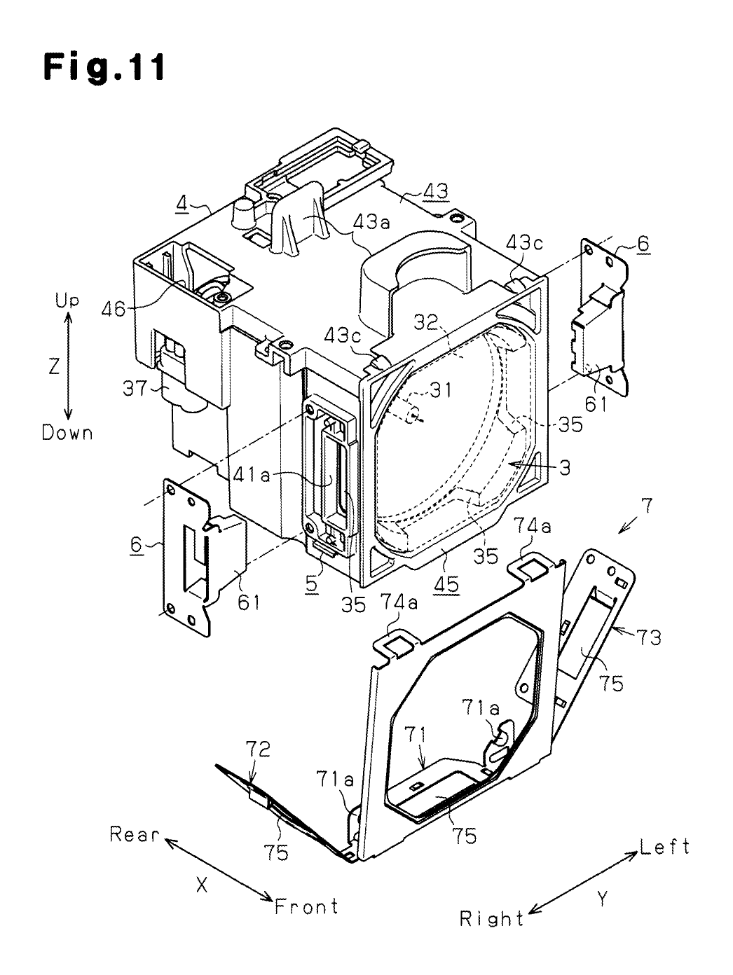

As shown in FIG. 11, after accommodating the lamp 3 in the lamp housing 4, two current deflectors 6 are fitted into the two inlets 35, respectively. Then, an outer frame 7 is coupled to the lamp housing 4 to prevent separation of the lamp 3.

Each current deflector 6 is formed by, for example, a metal plate. The current deflector 6 includes a deflection plate 61, which extends from the inlet 35 and into the lamp 3. In the present embodiment, the right inlet 35 and left inlet 35 of the lamp 3 are each provided with the current deflector 6. This ensures that a cooling current is guided to the arc tube 31 regardless of whether the cooling current enters the lamp 3 through the right inlet 35 or left inlet 35 of the lamp 3.

The outer frame 7 is formed by a metal plate in the same manner as the current deflector 6. The outer frame 7 includes a basal portion 71, a right frame portion 72, a left frame portion 73, and a tetragonal frame portion 74. The basal portion 71 is flat and extends in the leftward and rightward directions. The right frame portion 72 is connected to the right end of the basal portion 71 and bendable relative to the basal portion 71. The left frame portion 73 is connected to the left end of the basal portion 71 and bendable relative to the basal portion 71.

The basal portion 71 includes elastic sections 71a arranged on left and right rear ends of the basal portion 71 to apply elastic force in the forward and rearward directions. The elastic sections 71a are bent upward from the basal portion 71. The tetragonal frame portion 74 is connected to the front end of the basal portion 71 and bent upward from the basal portion 71. The tetragonal frame portion 74 has an upper end bent rearward to form hooking sections 74a. The hooking sections 74a are hooked to projections 43c arranged on the upper wall 43 of the lamp housing 4.

In the present embodiment, before coupling the outer frame 7 to the lamp housing 4, the deflection plates 61 are fitted into the inlets 35, which are arranged in the left and right ends of the lamp 3, to couple the current deflectors 6 to the lamp housing 4. In this state, the elastic sections 71a press the left and right lower ends of the reflector 32 forward. More specifically, the elastic sections 71a press the lower end of the lamp 3 against the front wall 45 of the lamp housing 4. Further, the hooking sections 74a are hooked to the projections 43c so that the basal portion 71 of the outer frame 7 presses the lower end of the upper wall 43 upward. As a result, the upper surface 32a of the reflector 32 is pressed against the upper wall 43. In this manner, the outer frame 7 presses the lamp 3 against the lamp housing 4 in the forward and rearward directions. The outer frame 7 also presses the lamp 3 against the lamp housing 4 in the upward and downward directions.

As shown in FIG. 2B, the basal portion 71 includes an opening 71b. The opening 71b is arranged at a position overlapped with the inlet 35 arranged in the lower end of the lamp 3 as viewed from below. Further, in the same manner as the basal portion 71, the left frame portion 73 includes an opening 73a. As shown in FIG. 2A, the right frame portion 72 also includes an opening 72a. The opening 72a is arranged at a position overlapped with the inlet 35 arranged in the right end of the lamp 3 as viewed from the right. The opening 73a is arranged at a position overlapped with the inlet 35 arranged in the left end of the lamp 3 as viewed from the left.

A grid 75 is arranged in each of the openings 71b, 72a, and 73a. The grid 75 is formed, for example, from a metal mesh, and fixed to the outer frame 7 by performing spot welding. When the arc tube 31 breaks, the grid 75 prevents fragments of the arc tube 31 from scattering outside the lamp unit 2.

As shown in FIG. 2, the right frame portion 72 and left frame portion 73 are fixed by screws 76 to the lamp housing 4. The screws 76 also fix the current deflectors 6 to the lamp housing 4 together with the right frame portion 72 and the left frame portion 73. After coupling the outer frame 7 to the lamp housing 4, as shown in FIG. 2A, a cover 81, which covers an opening 46 formed in the lamp housing 4, and an IC chip 82, which stores information related to the lamp unit 2, are fastened by screws to the lamp housing 4. Further, as shown in FIG. 2B, the connector 37 is fastened by a screw to the lamp housing 4, and a cable cover 83 is arranged on the lamp housing 4 to cover the cables 36.

The projector 1 that includes the lamp unit 2 uses the lamp 3 to display an image. For example, the projector 1, which includes liquid crystal panels, passes the light emitted from the lamp 3 through the liquid crystal panels to generate an image and project the image onto a screen or the like for display. When the life of the lamp 3 ends and the lamp 3 can no longer be illuminated, the lamp unit 2 is replaced with a new one to replace the lamp 3 with a new one.

The lamp holder 5 of the present embodiment has the advantages described below.

(1) The lamp holder 5, which holds the lamp 3 in the lamp housing 4, includes the elastic portions 52b and 53b, which are elastic and held between the inner surface 4b of the lamp housing 4 and the lamp 3. Further, the lamp holder 5 includes the hooking portions 52c and 53c, which are fitted into the openings 41b and 42b extending through the lamp housing 4 and hooked to the outer surface 4a of the lamp housing 4. The elastic portions 52b and 53b are held between the inner surface 4b of the lamp housing 4 and the lamp 3 to rigidly hook the hooking portions 52c and 53c to the outer surface 4a of the lamp housing 4. This rigidly fixes the lamp holder 5 to the lamp housing 4. The hooking portions 52c and 53c cannot be removed from the openings 41b and 42b of the lamp housing 4 until the hooking portions 52c and 53c are unhooked from the outer surface 4a of the lamp housing 4. This prevents the hooking portions 52c and 53c, which are parts of the lamp holder 5, from being separated from the openings 41b and 42b of the lamp housing 4. Further, the lamp holder 5 is easily fixed to the lamp housing 4 with a simple structure and without using a fastener such as a screw. This reduces the number of components. Accordingly, the lamp holder 5 is rigidly fixed to the lamp housing 4 with a simple structure.

(2) The lamp unit 2 includes the lamp holder 5 and the lamp housing 4, which accommodates the lamp 3. The elastic portions 52b and 53b are held between the inner surface 4b of the lamp housing 4 and the lamp 3 so that the hooking portions 52c and 53c are pressed against and hooked to the outer surface 4a of the lamp housing 4. Thus, the elastic portions 52b and 53b of the lamp holder 5 are held between the inner surface 4b of the lamp housing 4 and the lamp 3 to rigidly fix the lamp holder 5 to the lamp housing 4. This allows for accurate positioning of the optical axis of the lamp 3.

(3) The hooking portions 52c and 53c include the abutment sections 52d and 53d, which abut the outer surface 4a of the lamp housing 4, and the connection sections 52e and 53e, which are fitted into the openings 41b and 42b and connect the elastic portions 52b and 53b to the abutment sections 52d and 53d. Thus, the connection sections 52e and 53e are drawn into the lamp housing 4, and the abutment sections 52d and 53d, which are connected to the connection sections 52e and 53e, are pressed against the outer surface 4a of the lamp housing 4.

(4) The elastic portions 52b and 53b are held between the inner surface 4b of the lamp housing 4 and the lamp 3 to draw the connection sections 52e and 53e into the lamp housing 4. This presses the abutment sections 52d and 53d, which are connected to the elastic portions 52b and 53b by the connection sections 52e and 53e. Thus, the force acting on the connection sections 52e and 53e, which connect the elastic portions 52b and 53b to the abutment sections 52d and 53d, forms a force that presses the abutment sections 52d and 53d to the outer surface 4a of the lamp housing 4.

(5) The projector 1 includes the lamp unit 2 and holds the lamp 3, which is used as a light source for displaying an image, in the lamp housing 4 with the lamp holder 5. This obtains advantages (1) to (4) and allows for accurate positioning of the optical axis of the lamp 3.

It should be apparent to those skilled in the art that the present invention may be embodied in many other specific forms without departing from the spirit or scope of the invention. Particularly, it should be understood that the present invention may be embodied in the following forms.

The lamp holder 5 does not have to hold the left and right sides of the lamp 3. Further, the shape of the lamp holder 5 may be changed. For example, the right holding arm 52 and left holding arm 53 of the lamp holder 5 may be separable. Further, for example, the lamp holder 5 may hold only one of the left and right sides of the lamp 3.

The video projector is not limited to the projector 1, which generates an image by passing light through liquid crystal panels. For example, the present invention may be applied to a projector that generates an image by selectively reflecting light using a digital micromirror device (DMD).

The present examples and embodiments are to be considered as illustrative and not restrictive, and the invention is not to be limited to the details given herein, but may be modified within the scope and equivalence of the appended claims.

1. A lamp holder that holds a lamp, which is a light source for displaying an image, in a lamp housing, the lamp holder comprising:
an elastic portion held between the lamp and an inner surface of the lamp housing; and
a hooking portion fitted into an opening extending through the lamp housing and hooked to an outer surface of the lamp housing.

2. The lamp holder according to claim 1, wherein the hooking portion includes:
an abutment section that abuts the outer surface of the lamp housing; and
a connection section that connects the elastic portion and the abutment section, wherein the connection section is fitted into the opening.

3. The lamp holder according to claim 2, wherein the elastic portion is formed so that when the elastic portion is held between the lamp and the inner surface of the lamp housing, a force drawing the connection section into the lamp housing acts on the connection section thereby pressing the abutment section against the outer surface of the lamp housing.

4. The lamp holder according to claim 1, further comprising:
a first holding portion; and
a second holding portion opposed to the first holding portion, wherein the first and second holding portions each include the elastic portion and the hooking portion.

5. The lamp holder according to claim 4, wherein the elastic portion includes a curved portion that is bulged toward the lamp.

6. The lamp holder according to claim 5, wherein the first and second holding portions each include a flat portion connected in parallel to the curved portion.

7. The lamp holder according to claim 4, further comprising a basal portion that connects the first holding portion and the second holding portion, wherein:
the first holding portion, the second holding portion, and the basal portion are connected in a C-shaped manner to hold the lamp from three directions; and
the basal portion includes a second elastic portion that presses the lamp against the lamp housing from a direction orthogonal to the three directions.

8. A lamp unit comprising:
a lamp housing that accommodates a lamp; and
a lamp holder that holds the lamp in the lamp housing, wherein the lamp holder includes:
an elastic portion held between the lamp and an inner surface of the lamp housing; and
a hooking portion fitted into an opening extending through the lamp housing and hooked to an outer surface of the lamp housing.

9. The lamp unit according to claim 8, wherein the hooking portion includes:
an abutment section that abuts the outer surface of the lamp housing; and
a connection section that connects the elastic portion and the abutment section, wherein the connection section is fitted into the opening.

10. The lamp unit according to claim 9, wherein the elastic portion is formed so that when the elastic portion is held between the lamp and the inner surface of the lamp housing, a force drawing the connection section into the lamp housing acts on the connection section thereby pressing the abutment section against the outer surface of the lamp housing.

11. A video projector comprising:
a lamp serving as a light source for displaying an image; and
a lamp unit, wherein the lamp unit includes:
a lamp housing that accommodates the lamp; and
a lamp holder that holds the lamp in the lamp housing, wherein the lamp holder includes:
an elastic portion held between the lamp and an inner surface of the lamp housing; and
a hooking portion fitted into an opening extending through the lamp housing and hooked to an outer surface of the lamp housing.
